(19) United States
(12) Patent Application Publication
(10) Pub. No.: US 2015/0286812 A1
(43) Pub. Date: Oct. 8, 2015

(54) AUTOMATIC CAPTURE AND ENTRY OF ACCESS CODES USING A CAMERA

(71) Applicant: Microsoft Corporation, Redmond, WA (US)

(72) Inventors: Vishal Mhatre, Redmond, WA (US); Sunil Pai, Seattle, WA (US); Yatharth Gupta, Kirkland, WA (US); Gianluigi Nusca, Seattle, WA (US)

(21) Appl. No.: 14/245,977

(22) Filed: Apr. 4, 2014

(51) Int. Cl. G06F 21/34; G06F 21/35

(52) U.S. Cl. CPC G06F 21/34; G06F 21/35

(57) ABSTRACT

The manual entry of displayed access codes can be avoided by using a camera connected to or integrated with a computer system to capture an image of a display on another device containing a displayed access code. In response to an indication of where a pin is located in the captured image, optical character recognition is performed on the captured image to extract the access code and enter the access code into the computer system.

### BACKGROUND

In many computer systems, it is common for an application to present a user interface in which a user is prompted to enter an access code, often called a personal identification number (PIN). The access code is a sequence of characters, i.e., numbers and/or letters and/or symbols, which is typically short, e.g., about four to twelve characters. The access code typically is transmitted to another device, which in turn displays the access code on a display, or otherwise communicates the access code to the user. The user then enters the access code through the user interface of the computer system, typically using an alphanumeric keyboard, which can be a separate device connected to the computer or a “soft” keyboard displayed on a touch screen, such as on a tablet computer.

Such transmission of access codes generally is used as a form of authentication before allowing the computer system and the other device to communicate with each other. Such an exchange of access codes occurs, for example, when two devices connect over a Bluetooth wireless connection.

Another form of authentication can occur using one dimensional barcodes, two-dimensional matrix codes (e.g., quick response (QR) codes) or other optically scannable encoded information. However, both the computer system and the other device must have the capability of handling such codes. That is, one of the devices must be able to display a readable barcode, while the other of the devices must be able to read the barcode as displayed.

### SUMMARY

This Summary is provided to introduce a selection of concepts in a simplified form that are further described below in the Detailed Description. This Summary is intended neither to identify key or essential features, nor to limit the scope, of the claimed subject matter.

The manual entry of displayed access codes can be avoided by using a camera connected to or integrated with a computer system to capture an image of a display on another device containing a displayed access code. In response to an indication of where a pin is located in the captured image, optical character recognition is performed on the captured image to extract the access code and enter the access code into the computer system.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example application environment in which a computer system that automatically captures and enters access codes through a camera.

FIG. 2 is a data flow diagram describing an access code capture module.

FIGS. 3A and 3B are diagrams of an example graphical user interface.

FIG. 4 is a diagram of example data structures.

FIG. 5 is a flow chart describing operation of the access code capture module.

FIG. 6 is a block diagram of an example computer with which components of such a system can be implemented.

### DETAILED DESCRIPTION

The following section describes an example computer system that automatically captures and enters access codes through a camera.

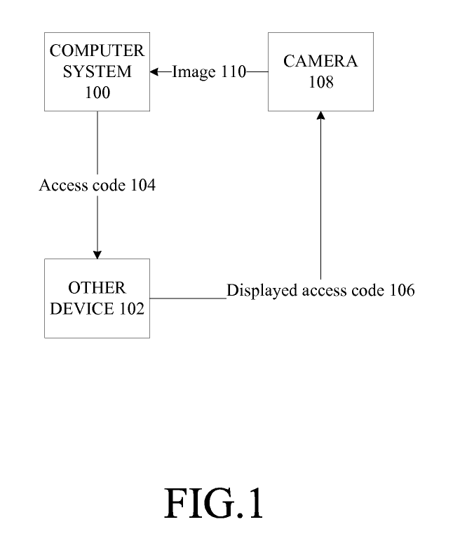

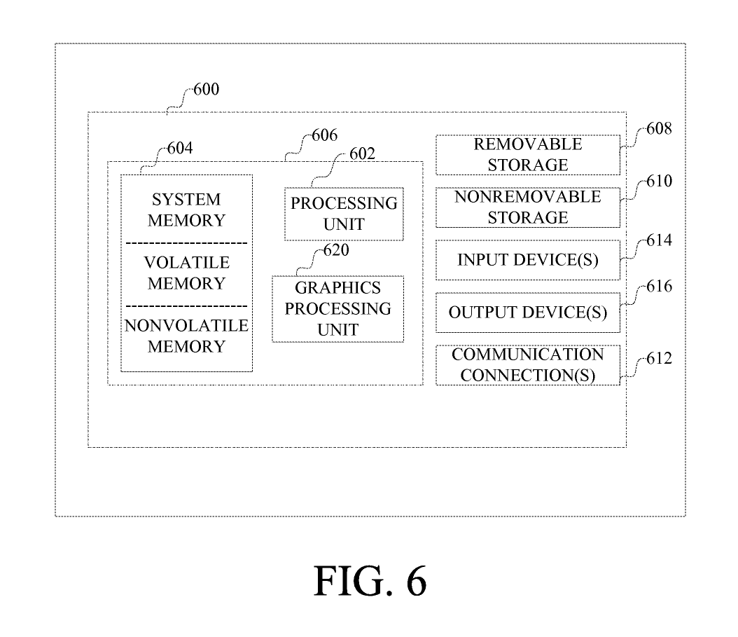

Referring to FIG. 1, in many computer systems, a pairing protocol is used to allow a computer system 100 and another device 102 to communicate with each other. The computer system can be any computer system, such as a tablet computer, hand held computer, smart phone, laptop or notebook computer, and the like, more details and examples of which are discussed below in connection with FIG. 6. The other device also can be any computer system, but also may be a peripheral device for a computer system, such as an input or output device, communication device, or the like, examples of which are discussed below in connection with FIG. 6.

Such a pairing protocol typically includes a form of authentication, in which the computer system 100 transmits an access code 104 to the other device 102. The access code is a sequence of characters, i.e., numbers and/or letters and/or symbols, which is typically short, e.g., about four to twelve characters. The other device presents the access code received from the computer system to an individual. In turn, the individual inputs the access code through a user interface to the computer system.

To provide a simple mechanism to enter the access code, the computer system is connected to or incorporates a camera 108 which captures an image 110 of the displayed access code 106 as presented on a display of the other device 102. The image is processed using character recognition, to extract the characters of the access code from the display. The extracted characters are presented to the application on the computer systems which requested entry of the access code. Using the camera avoids keypad-based entry of access codes, which can be cumbersome on touch-based devices, many of which today incorporate a camera.

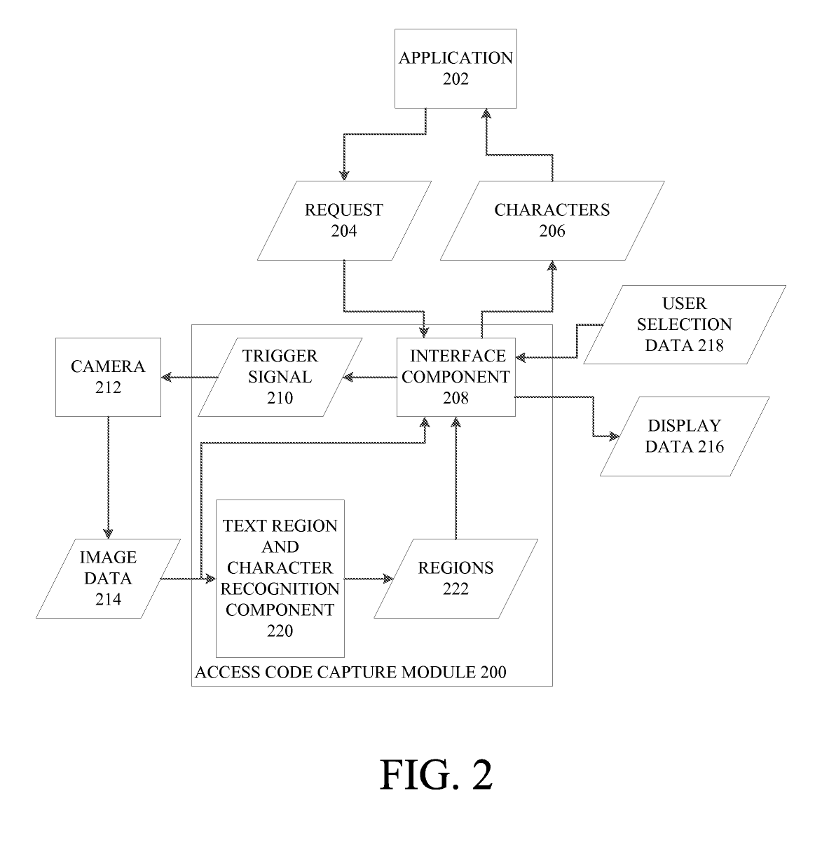

A data flow diagram of an example implementation of how an image captured by a camera can be processed to extract access codes will now be described in connection with FIG. 2.

In this example implementation, the computer system includes an access code capture module 200, which is provided as a component of the operating system. This module can be used by an application 202 to capture an access code. The application 202 issues a request 204 to capture an access code, in response to which the access code capture module 200 provides characters 206 of the access code. In this implementation, a user can identify a selected region of an image to assist in capturing the access code, thus the characters 206 are from a selected region of a captured image.

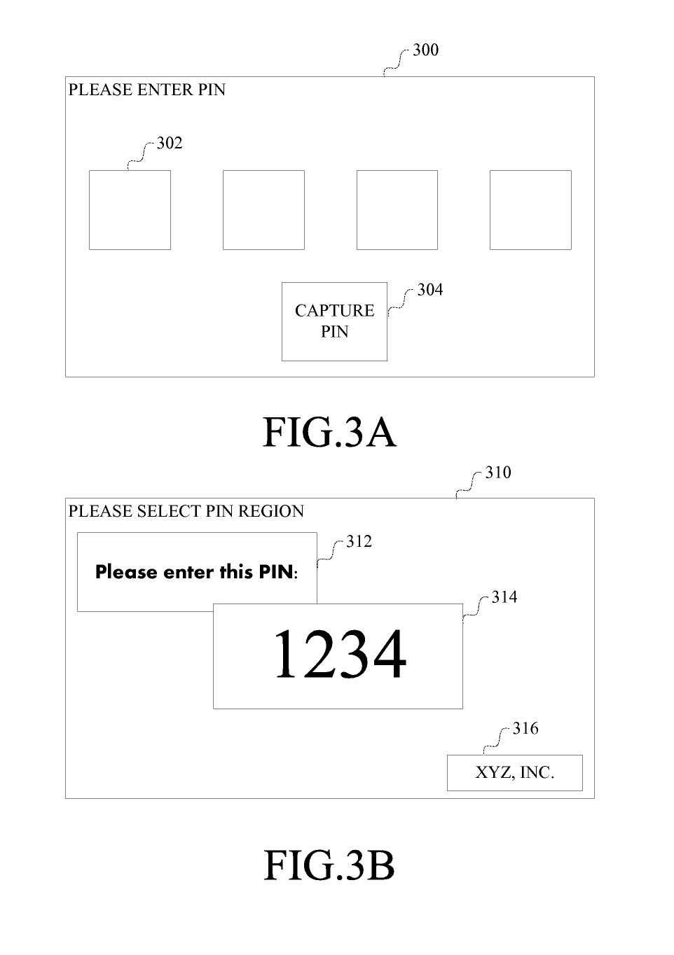

An interface component 208 receives and processes the request 204. A number of implementations are possible for the interface component, for which the task is to coordinate a user presenting the other device with the access code to the camera with the camera capturing an image of the other device for processing. In this example implementation, the interface component 208 generates first display data 216. This display data is for a graphical user interface to prompt the user to enter the access code. An example is described below in connection with FIG. 3A. The user may have an option of using a keyboard to enter the access code, but also may have an option to instruct the computer to use the camera to enter the access code by capturing and processing an image. If the user provides an instruction to capture an image of the access code, through user selection data 218, the user can be instructed to place the other device in front of the camera for an image of the other device to be captured. In turn, the interface component 208 provides a trigger signal 210 to instruct the camera 212 to capture image data 214. A variety of user interface techniques and coordination processes can be used to instruct the user and coordinate the timing of presenting the other device before the camera and triggering the camera to capture an image. For example, a graphical user interface for a camera controller can be activated.

A text region and character recognition component 220 receives the captured image data 214 from the camera 212, typically stored in memory of the computer to which the camera is connected or integrated. The text region and character recognition component 220 processes the image data to identify regions 222, which are areas in the image data that contain text. While it is possible that only one region of text, containing the desired access code, may be detected in an image, it is also possible that the image captures other extraneous data from a display, the other device itself, background or interfering foreground objects. Thus, any regions of characters are first identified, and the characters within those regions are recognized to provide region data 222. The text region and character recognition component can be implemented using conventional optical character recognition techniques, which, given an image, output data indicating characters and locations of those characters in the image.

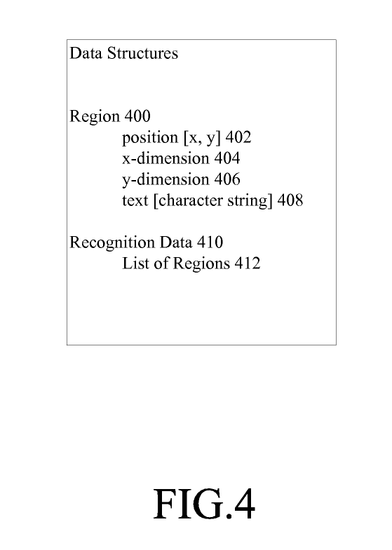

An example data structure for representing the region data output by the text region and character recognition component will now be described in connection with FIG. 4. A region 400 includes data defining its position 402 in the image, such as by x and y coordinates, and the length and width of the region, i.e., the x dimension 404 and the y dimension 406. A string 408 or other representation of the set of characters recognized in this region also are identified. If multiple regions can be identified, the recognition data 410 can include a list 412 of the regions, with each region in the list represented in the manner of region 400.

Referring back again to FIG. 2, the identified regions 222 are provided to the interface component 208. If only one string of characters is detected, the interface component 208 can provide the string as the characters 206 representing the input access code to the application 200. If multiple areas in the image 214 are determined to include characters, then the image 214, or portions thereof, can be presented to the user and the user can be prompted to indicate where the access codes are located in the image. In such a case, the interface component 208 presents second display data 216, an example implementation of which is shown in FIG. 3B, through a graphical user interface of the computer. User selection data 218 received by the interface component 208 is indicative of the region selected by the user. The interface component 208 provides the recognized characters from the selected region to the application 200 as the access code.

Example user interface displays are provided in FIGS. 3A and 3B. In FIG. 3A, a display area 300 is presented on a display. The display area includes a set of boxes 302 which are text entry boxes, allowing a user to input a character from the access code in each box. The specific form and behavior for the text entry is not pertinent to the present invention and there are many ways in which the text entry box can be configured and displayed. The display area 302 also can include a manipulable object 304 that invokes capturing an image of a pin. In this example implementation, a button labeled “Capture PIN” is shown. With such an implementation, a user can activate the button using any of various gestures, such as a click from a pointer device such as a mouse or a tap gesture on a touch screen.

In FIG. 3B, regions are displayed in an interface that allows a user to indicate where the access code is located in the image. A display area 310 is presented on a display, which includes a copy of the image captured by the camera, and may include a prompt to the user indicating that the region containing the access code should be selected. There may be several regions of text in a captured image that are not an access code. For example, as shown at region 312, the other device may display not just an access code, but a prompt such as “Please enter this PIN:”. As another example, a logo on a display may be captured in the image, as shown in region 316. If the camera was positioned properly, one region 314 contains the desired access code. The regions may be highlighted or delineated by boxes as shown in FIG. 3B. With such a display, a user can select a region using any of various gestures, such as a click from a pointer device such as a mouse or a tap gesture on a touch screen. It is possible that multiple regions are detected which, in combination, contain the access code, for example if the recognition module detected two regions instead of one within region 314. The user interface can be configured to allow a user to make multiple selections using conventional gestures for selecting multiple objects.

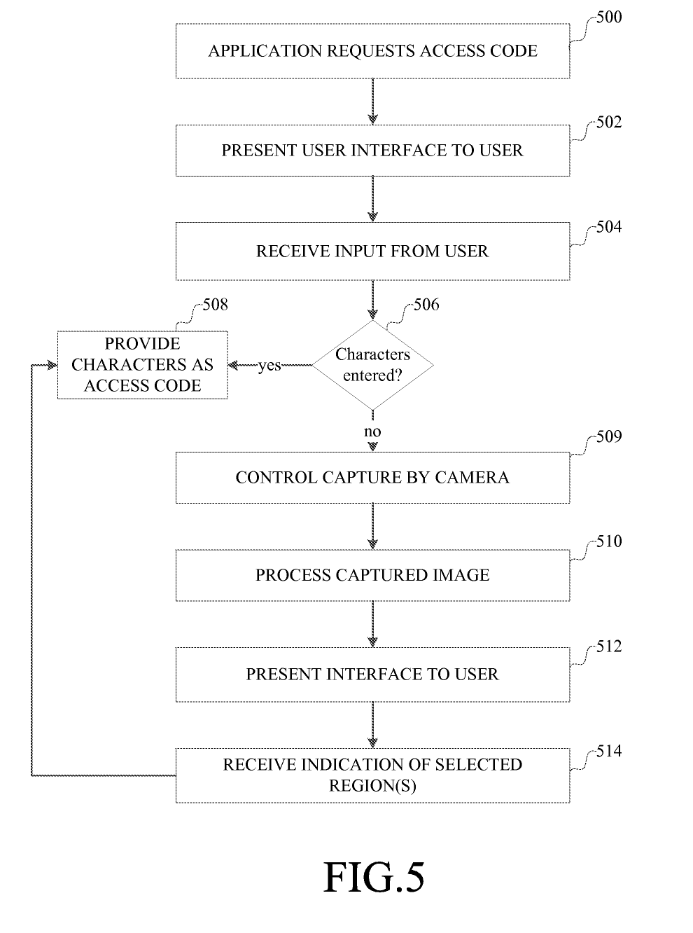

Referring now to FIG. 5, a flow chart describing operation of this example implementation will now be described.

In FIG. 5, an application requests 500 the computer system to receive an access code input from the user. The access code capture module presents 502 an interface to the user. The access code capture module then receives 504 an input, which can be either a character input from the user, or an indication from the user that an image containing the access code should be captured. If characters are entered, as determined at 506, the characters as entered are provided 508 to the application as the access code. Otherwise, the camera is controlled 509 to capture an image.

The captured image is processed 510 to extract one or more regions and recognize characters within those regions. The access code capture module presents 512 an interface to the user, and then receives 514 an input indicating one or more of the presented regions as the regions containing the access code. The characters recognized from the selected regions is provided 508 to the application as the access code.

With such an access code capture module on a computer, entering of access codes, particularly when pairing a tablet or other touch-centric device with another device, can be simplified by automatically extracting the access code from an image of the other device.

Having now described an example implementation, FIG. 6 illustrates an example computer in which such techniques can be implemented. This is only one example of a computer and is not intended to suggest any limitation as to the scope of use or functionality of such a computer. The following description is intended to provide a brief, general description of such a computer. The computer can be any of a variety of general purpose or special purpose computing hardware configurations. Examples of well-known computers that may be suitable include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, network PCs, minicomputers, mainframe computers, distributed computing environments that include any of the above systems or devices, and the like.

With reference to FIG. 6, an example computer 600, in a basic configuration, includes at least one processing unit 602 and memory 604. The computer can have multiple processing units 602. A processing unit 602 can include one or more processing cores (not shown) that operate independently of each other. Additional co-processing units, such as graphics processing unit 620, also can be provided. Depending on the configuration and type of computer, memory 604 may be volatile (such as RAM), non-volatile (such as ROM, flash memory, etc.) or some combination of the two. This configuration is illustrated in FIG. 6 by dashed line 606. The computer 600 also may include additional storage (removable and/or non-removable) including, but not limited to, magnetic or optical disks or tape. Such additional storage is illustrated in FIG. 6 by removable storage 608 and non-removable storage 610.

A computer storage medium is any medium in which data can be stored in and retrieved from addressable physical storage locations by the computer. Computer storage media includes volatile and nonvolatile, removable and non-removable media. Memory 604, removable storage 608 and non-removable storage 610 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

Computer 600 may also contain communications connection(s) 612 that allow the device to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media. Communications connections 612 are devices, such as a network interface or radio transmitter, that interface with the communication media to transmit data over and receive data from communication media.

Computer 600 may have various input device(s) 614 such as a keyboard, mouse, pen, camera, touch input device, and so on. Output device(s) 616 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

Each component of this system that operates on a computer generally is implemented using one or more computer programs processed by one or more processing units in the computer. A computer program includes computer-executable instructions and/or computer-interpreted instructions, which instructions are processed by one or more processing units in the computer. Generally, such instructions define routines, programs, objects, components, data structures, and so on, that, when processed by a processing unit, instruct the processing unit to perform operations on data, or configure the computer to include various devices or data structures. This computer system may be practiced in distributed computing environments where tasks are performed by remote processing devices that are linked through a communications network. In a distributed computing environment, computer programs may be located in both local and remote computer storage media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A process for providing an access code to a computer, comprising:
causing the access code to be displayed on a display of another device;
capturing an image of the display of the other device;
extracting characters from the captured image; and
providing the extracted characters to the computer as the access code.

2. The process of claim 1 wherein the computer is a tablet computer.

3. The process of claim 1 wherein the access code is for pairing the computer with the other device.

4. The process of claim 1 further comprising presenting an interface on the computer requesting the user to enter the access code.

5. The process of claim 4, wherein the interface includes a mechanism for the user to enter characters of the access code and a mechanism for the user to activate the capturing of the image.

6. The process of claim 1 wherein capturing of the image is performed by a camera connected to the computer.

7. The process of claim 1, further comprising presenting an interface on the computer requesting the user to select a region of the captured image that includes the access code.

8. A computer program product, comprising:
a computer storage device;
computer program instructions stored in the computer storage device that when read from the storage device and processed by a processor of a computer instruct the computer to perform a process for entering an access code to a computer, the process comprising:
causing the access code to be displayed on a display of another device;
capturing an image of the display of the other device;
extracting characters from the captured image; and
providing the extracted characters to the computer as the access code.

9. The computer program product of claim 8, wherein the computer is a tablet computer.

10. The computer program product of claim 8, wherein the access code is for pairing the computer with the other device.

11. The computer program product of claim 8, further comprising presenting an interface on the computer requesting the user to enter the access code.

12. The computer program product of claim 8, wherein the interface includes a mechanism for the user to enter characters of the access code and a mechanism for the user to activate the capturing of the image.

13. The computer program product of claim 8, wherein capturing of the image is performed by a camera connected to the computer.

14. The computer program product of claim 8, further comprising presenting an interface on the computer requesting the user to select a region of the captured image that includes the access code.

15. A computer comprising:
a processor and memory including at least one computer program that when executed defines an application running on the computer;
a camera;
an access code capture module having a first input receiving a request for an access code from an application running on the computer, and output for controlling the camera to capture an image, a second input for receiving the captured image from the camera, and an output providing to the application an access code extracted from the captured image.

16. The computer of claim 15, wherein the computer is a tablet computer.

17. The computer of claim 15, wherein the access code is for pairing the computer with the other device.

18. The computer of claim 15, further comprising a display that displays an interface on the computer requesting the user to enter the access code.

19. The computer of claim 15, wherein the interface includes a mechanism for the user to enter characters of the access code and a mechanism for the user to activate the capturing of the image.

20. The computer of claim 15, wherein the display further displays an interface on the computer requesting the user to select a region of the captured image that includes the access code.
